(19) United States
(12) Patent Application Publication
(10) Pub. No.: US 2024/0239951 A1
(43) Pub. Date: Jul. 18, 2024

(54) Cured Epoxy Resin and Method of Curing an Epoxy Resin Using an Amine Compound

(71) Applicant: SI Group, Inc., The Woodlands, TX (US)

(72) Inventor: Qiang Luo, Houston, TX (US)

(21) Appl. No.: 18/398,307

(22) Filed: Dec. 28, 2023

Related U.S. Application Data
(60) Provisional application No. 63/580,009, filed on Sep. 1, 2023.
(60) Provisional application No. 63/435,840, filed on Dec. 29, 2022.

(51) Int. Cl. C08G 59/50; C08G 59/24

(52) U.S. Cl. CPC C08G 59/5033; C08G 59/245

(57) ABSTRACT

The present disclosure is directed to a cured epoxy resin and a method of forming a cured epoxy resin. The method comprises: curing an epoxy resin in the presence of an amine compound comprising a diamine, a triamine, or a mixture thereof. The cured epoxy resin has a shear modulus at failure of 55 MPa or more as determined in accordance with ASTM 5045-14.

### CROSS-REFERENCE TO RELATED APPLICATIONS

The present application claims filing benefit of U.S. Provisional Patent Application No. 63/435,840 having a filing date of Dec. 29, 2022 and U.S. Provisional Patent Application No. 63/580,009 having a filing date of Sep. 1, 2023, both of which are hereby incorporated by reference in their entirety.

### BACKGROUND OF THE DISCLOSURE

Epoxy resins have been used extensively for a variety of applications, such as adhesives, coatings, etc., in many industries. Typically, epoxy resins are converted from a liquid state to a thermoset solid by curing using a curing agent which becomes a part of the cured epoxy resin. However, certain traditional curing agents have a general bulky structure. In this regard, such structure may negatively impact the mechanical properties, such as flexibility, toughness, and strength, of the cured epoxy resin which may make it undesirable for particular applications. To offset such negative impact, these cured epoxy resins may include impact modifiers in relatively considerable amounts in order to attain the desired mechanical properties. However, the use of such impact modifiers in increased amounts may render the curing process more complex as well as increase the costs of the process and resulting cured epoxy resin.

As such, a need continues to exist for an improved, cured epoxy resin having a balance of properties.

### SUMMARY OF THE DISCLOSURE

In accordance with one embodiment of the present disclosure, a method of forming a cured epoxy resin is disclosed. The method comprises: curing an epoxy resin in the presence of an amine compound comprising a diamine, a triamine, or a mixture thereof. The cured epoxy resin has a shear modulus at failure of 55 MPa or more as determined in accordance with ASTM 5045-14.

In accordance with another embodiment of the present disclosure, a cured epoxy resin is disclosed. The cured epoxy resin is formed by curing an epoxy resin in the presence of an amine compound comprising a diamine, a triamine, or a mixture thereof. The cured epoxy resin has a shear modulus at failure of 55 MPa or more as determined in accordance with ASTM 5045-14.

### BRIEF DESCRIPTION OF THE DRAWINGS

FIG. 1 is a bar graph of shear moduli at failure of certain samples of Example 1 containing one or more amine compounds.

FIG. 2 is a bar graph of the critical stress intensity factor of certain samples of Example 1 containing one or more amine compounds.

### DETAILED DESCRIPTION

It is to be understood by one of ordinary skill in the art that the present discussion is a description of exemplary embodiments only and is not intended as limiting the broader aspects of the present disclosure.

Generally speaking, the present disclosure is directed to the use of amine compounds, typically used as amine antioxidants, as curing agents for epoxy resins to form a cured epoxy resin. In this regard, the present disclosure is directed to a cured epoxy resin and a method of forming a cured epoxy resin. Without intending to be limited, the present inventor has discovered that the amine compounds as disclosed herein can be utilized to optimize the crosslink density of the cured epoxy resin in order to balance the mechanical properties of the cured epoxy resin. In addition, the cured epoxy resin may exhibit improved adhesion characteristics, in particular for low surface energy substrates.

For instance, by utilizing the amine compound as disclosed herein, the cured epoxy resin may exhibit a desired shear modulus at failure. Without intending to be limited, the shear modulus at failure provides an indication regarding the stiffness of the cured epoxy resin or the ability of the cured epoxy resin to resist deformation. In this regard, generally, the higher the shear modulus at failure, the more likely the cured epoxy resin will resist deformation. The cured epoxy resin may exhibit a shear modulus at failure of 1 MPa or more, such as 5 MPa or more, such as 10 MPa or more, such as 15 MPa or more, such as 20 MPa or more, such as 25 MPa or more, such as 30 MPa or more, such as 35 MPa or more, such as 40 MPa or more, such as 50 MPa or more, such as 55 MPa or more, such as 60 MPa or more, such as 70 MPa or more, such as 80 MPa or more, such as 90 MPa or more, such as 100 MPa or more, such as 120 MPa or more, such as 140 MPa or more, such as 160 MPa or more, such as 180 MPa or more, such as 200 MPa or more, such as 240 MPa or more, such as 280 MPa or more, such as 320 MPa or more, such as 360 MPa or more, such as 400 MPa or more. The shear modulus at failure may be 500 MPa or less, such as 450 MPa or less, such as 400 MPa or less, such as 380 MPa or less, such as 350 MPa or less, such as 330 MPa or less, such as 330 MPa or less, such as 280 MPa or less, such as 250 MPa or less, such as 230 MPa or less, such as 210 MPa or less, such as 200 MPa or less, such as 180 MPa or less, such as 160 MPa or less, such as 140 MPa or less, such as 130 MPa or less, such as 120 MPa or less, such as 110 MPa or less, such as 100 MPa or less, such as 95 MPa or less, such as 90 MPa or less, such as 80 MPa or less, such as 75 MPa or less, such as 70 MPa or less, such as 65 MPa or less, such as 60 MPa or less. The shear modulus at failure may be determined in accordance with ASTM 5045-14.

In addition, by utilizing the amine compound as disclosed herein, the cured epoxy resin may exhibit a desired critical stress intensity factor (K_{IC}). Without intending to be limited, the critical stress intensity factor (K_{IC}) provides an indication regarding the resistance of the cured epoxy resin to crack extension. The cured epoxy resin may exhibit a critical stress intensity factor (K_{IC}) of 0.01 MPa·m^{1/2} or more, such as 0.05 MPa·m^{1/2} or more, such as 0.1 MPa·m^{1/2} or more, such as 0.2 MPa·m^{1/2} or more, such as 0.25 MPa·m^{1/2} or more, such as 0.3 MPa-m^{1/2} or more, such as 0.4 MPa·m^{1/2} or more, such as 0.5 MPa·m^{1/2} or more, such as 0.6 MPa·m^{1/2} or more, such as 0.7 MPa·m^{1/2} or more, such as 0.8 MPa·m^{1/2} or more, such as 0.9 MPa·m^{1/2} or more, such as 1 MPa·m^{1/2} or more, such as 1.2 MPa·m^{1/2} or more, such as 1.3 MPa·m^{1/2} or more, such as 1.4 MPa·m^{1/2} or more, such as 1.6 MPa·m^{1/2} or more, such as 1.8 MPa·m^{1/2} or more, such as 1.9 MPa-m^{1/2} or more, such as 2 MPa·m^{1/2} or more. The critical stress intensity factor (K_{IC}) may be 5 MPa·m^{1/2} or less, such as 4.5 MPa·m^{1/2} or less, such as 4 MPa·m^{1/2} or less, such as 3.8 MPa·m^{1/2} or less, such as 3.5 MPa·m^{1/2} or less, such as 3.3 MPa·m^{1/2} or less, such as 3 MPa-m^{1/2} or less, such as 2.8 MPa·m^{1/2} or less, such as 2.6 MPa-m^{1/2} or less, such as 2.4 MPa·m^{1/2} or less, such as 2.2 MPa·m^{1/2} or less, such as 2.1 MPa-m^{1/2} or less, such as 2 MPa·m^{1/2} or less, such as 1.9 MPa·m^{1/2} or less, such as 1.8 MPa·m^{1/2} or less, such as 1.7 MPa·m^{1/2} or less, such as 1.6 MPa·m^{1/2} or less, such as 1.5 MPa·m^{1/2} or less, such as 1.4 MPa·m^{1/2} or less, such as 1.3 MPa·m^{1/2} or less, such as 1.2 MPa·m^{1/2} or less. The critical stress intensity factor (K_{IC}) may be determined in accordance with ASTM 5045-14.

Further, regarding the crosslink density, the cured epoxy resin may generally be more linear in nature due to the use of the amine compound as disclosed herein. However, the cured epoxy resin may have a particular crosslink density as indicated by an average molecular weight between crosslinks (Mc). For instance, Mc may be 30 Da or more, such as 50 Da or more, such as 100 Da or more, such as 500 Da or more, such as 1,000 Da or more, 2,000 Da or more, such as 3,000 Da or more, such as 4,000 Da or more, such as 5,000 Da or more, such as 6,000 Da or more, such as 7,000 Da or more, such as 8,000 Da or more, such as 9,000 Da or more, such as 10,000 Da or more, such as 10,000 Da or more, such as 15,000 Da or more, such as 18,000 Da or more, such as 20,000 Da or more, such as 25,000 Da or more, such as 30,000 Da or more, such as 40,000 Da or more, such as 50,000 Da or more, such as 60,000 Da or more, such as 70,000 Da or more, such as 80,000 Da or more, such as 90,000 Da or more, such as 100,000 Da or more, such as 125,000 Da or more, such as 150,000 Da or more, such as 175,000 Da or more, such as 200,000 Da or more. The value for Mc may be 400,000 Da or less, such as 350,000 Da or less, such as 300,000 Da or less, such as 250,000 Da or less, such as 200,000 Da or less, such as 175,000 Da or less, such as 150,000 Da or less, such as 125,000 Da or less, such as 100,000 Da or less, such as 90,000 Da or less, such as 80,000 Da or less, such as 70,000 Da or less, such as 60,000 Da or less, such as 50,000 Da or less, such as 40,000 Da or less, such as 30,000 Da or less, such as 20,000 Da or less, such as 18,000 Da or less, such as 15,000 Da or less, such as 13,000 Da or less, such as 10,000 Da or less, such as 9,000 Da or less, such as 8,000 Da or less, such as 7,000 Da or less, such as 6,000 Da or less, such as 5,000 Da or less, such as 4,000 Da or less, such as 3,000 Da or less, such as 2,000 Da or less, such as 1,000 Da or less, such as 800 Da or less, such as 500 Da or less, such as 400 Da or less, such as 300 Da or less. Mc may be determined in accordance with previously published procedures such as those disclosed in U.S. Pat. No. 11,180,651, which is incorporated herein by reference in its entirety.

Also, by utilizing the amine compound as disclosed herein, the cured epoxy resin may exhibit a certain glass transition temperature. In general, the glass transition temperature may provide an indication regarding the temperature at which the cured epoxy resin transitions from being rigid/glassy to being rubbery/more flexible. The glass transition temperature may be 0° C. or more, such as 10° C. or more, such as 20° C. or more, such as 30° C. or more, such as 40° C. or more, such as 50° C. or more, such as 60° C. or more, such as 65° C. or more, such as 70° C. or more, such as 75° C. or more, such as 80° C. or more, such as 90° C. or more, such as 100° C. or more, such as 110° C. or more, such as 130° C. or more, such as 150° C. or more, such as 170° C. or more, such as 190° C. or more. The glass transition temperature may be 300° C. or less, such as 280° C. or less, such as 260° ° C. or less, such as 240° C. or less, such as 220° C. or less, such as 200° C. or less, such as 180ºC or less, such as 160° C. or less, such as 140° C. or less, such as 120° C. or less, such as 110° C. or less, such as 100° C. or less, such as 90° C. or less, such as 80° C. or less, such as 70° C. or less, such as 60° C. or less, such as 50° C. or less. In one embodiment, the glass transition of the cured epoxy resin may occur over a temperature range. In this regard, such temperature range may be a range based on the aforementioned temperatures. The glass transition temperature may be determined using means generally known in the art, such as differential scanning calorimetry with a ramp rate of 10° C./minute.

### Epoxy Resin

As indicated herein, an amine compound may function as an effective curing agent for an epoxy resin. In this regard, the epoxy resin is not necessarily limited by the present disclosure. For instance, the epoxy resin may have one or more, such as two or more epoxy functional groups. In one embodiment, the epoxy resin may have two epoxy functional groups. The epoxy functional groups may be glycidyl groups. Such groups may be present as terminal groups in one embodiment. In another embodiment, such groups may be present as branched groups. Nevertheless, such groups may be present to allow for curing, particularly using the amine compound as disclosed herein.

In one embodiment, a suitable epoxy resin may be a liquid epoxy resin in one embodiment. In general, a liquid epoxy resin may refer to a resin, such as a polyepoxide, having a glass transition temperature below 25° C.

In addition, the epoxy resin may be obtained using methods generally known in the art. For instance, an epoxy resin may be made from the oxidation of a corresponding olefin or from the reaction of epichlorohydrin with a corresponding polyol, polyphenol, or amine. Regardless, the particular method of forming the epoxy resin is not necessarily limited by the present disclosure.

The epoxy resin may be an aromatic epoxy resin, an aliphatic resin, or a mixture thereof. For instance, the epoxy resin may be an aromatic epoxy resin in one embodiment. In particular, the epoxy resin may be an aromatic group containing glycidyl ether-based epoxy resin. In another embodiment, the epoxy resin may be an aliphatic epoxy resin. For instance, the aliphatic epoxy resin may in particular be a cycloaliphatic epoxy resin.

In one embodiment, the epoxy resin may be a glycidyl ether. In another embodiment, the epoxy resin may be a diglycidyl ether.

As indicated above, the epoxy resin may include, but is not limited to, an aromatic epoxy resin in one embodiment. For instance, these may include, but are not limited to, a glycidyl ether of:
bisphenol A, bisphenol F or bisphenol A/F, where A stands for acetone and F for formaldehyde, which served as reactants for the preparation of these bisphenols; wherein in the case of bisphenol F, positional isomers may also be present, especially derived from 2,4′- or 2,2′-hydroxyphenylmethane;
dihydroxybenzene derivatives such as resorcinol, hydroquinone or catechol;
further bisphenols or polyphenols such as bis(4-hydroxy-3-methylphenyl)methane, 2,2-bis(4-hydroxy-3-methylphenyl)propane (bisphenol C), bis(3,5-dimethyl-4-hydroxyphenyl)methane, 2,2-bis(3,5-dimethyl-4-hydroxyphenyl)propane, 2,2-bis(3,5-dibromo-4-hydroxyphenyl)propane, 2,2-bis(4-hydroxy-3-tert-butylphenyl)propane, 2,2-bis(4-hydroxyphenyl)butane (bisphenol B), 3,3-bis(4-hydroxyphenyl)pentane, 3,4-bis(4-hydroxyphenyl)hexane, 4,4-bis(4-hydroxyphenyl)heptane, 2,4-bis(4-hydroxyphenyl)-2-methylbutane, 2,4-bis(3,5-dimethyl-4-hydroxyphenyl)-2-methylbutane, 1,1-bis(4-hydroxyphenyl)cyclohexane (bisphenol Z), 1,1-bis(4-hydroxyphenyl)-3,3,5-trimethylcyclohexane (bisphenol TMC), 1,1-bis(4-hydroxyphenyl)-1-phenylethane, 1,4-bis[2-(4-hydroxyphenyl)-2-propyl]benzene (bisphenol P), 1,3-bis[2-(4-hydroxyphenyl)-2-propyl]benzene (bisphenol M), 4,4′-dihydroxydiphenyl (DOD), 4,4′-dihydroxybenzophenone, bis(2-hydroxynaphth-1-yl)methane, bis(4-hydroxynaphth-1-yl)methane, 1,5-dihydroxynaphthalene, tris(4-hydroxyphenyl)methane, 1,1,2,2-tetrakis(4-hydroxyphenyl)ethane, bis(4-hydroxyphenyl) ether or bis(4-hydroxyphenyl) sulfone;
novolaks, which are especially condensation products of phenol or cresols with formaldehyde or paraformaldehyde or acetaldehyde or crotonaldehyde or isobutyraldehyde or 2-ethylhexanal or benzaldehyde or furfural;
aromatic amines such as aniline, toluidine, 4-aminophenol, 4,4′-methylenediphenyldiamine, 4,4′-methylenediphenyldi(N-methyl)amine, 4,4′-[1,4-phenylenebis(1-methylethylidene)]bisaniline (bisaniline P) or 4,4′-[1,3-phenylenebis(1-methylethylidene)]bisaniline (bisaniline M).

In one embodiment, the epoxy resin may be a diglycidyl ether of the aforementioned to the extent such compound is capable of forming a diglycidyl ether. For instance, the epoxy resin may be a diglycidyl ether of:
bisphenol A, bisphenol F or bisphenol A/F, where A stands for acetone and F for formaldehyde, which served as reactants for the preparation of these bisphenols; wherein in the case of bisphenol F, positional isomers may also be present, especially derived from 2,4′- or 2,2′-hydroxyphenylmethane;
dihydroxybenzene derivatives such as resorcinol, hydroquinone or catechol;

further bisphenols or polyphenols such as bis(4-hydroxy-3-methylphenyl)methane, 2,2-bis(4-hydroxy-3-methylphenyl)propane (bisphenol C), bis(3,5-dimethyl-4-hydroxyphenyl)methane, 2,2-bis(3,5-dimethyl-4-hydroxyphenyl)propane, 2,2-bis(3,5-dibromo-4-hydroxyphenyl)propane, 2,2-bis(4-hydroxy-3-tert-butylphenyl)propane, 2,2-bis(4-hydroxyphenyl)butane (bisphenol B), 3,3-bis(4-hydroxyphenyl)pentane, 3,4-bis(4-hydroxyphenyl)hexane, 4,4-bis(4-hydroxyphenyl)heptane, 2,4-bis(4-hydroxyphenyl)-2-methylbutane, 2,4-bis(3,5-dimethyl-4-hydroxyphenyl)-2-methylbutane, 1,1-bis(4-hydroxyphenyl)cyclohexane (bisphenol Z), 1,1-bis(4-hydroxyphenyl)-3,3,5-trimethylcyclohexane (bisphenol TMC), 1,1-bis(4-hydroxyphenyl)-1-phenylethane, 1,4-bis[2-(4-hydroxyphenyl)-2-propyl]benzene (bisphenol P), 1,3-bis[2-(4-hydroxyphenyl)-2-propyl]benzene (bisphenol M), 4,4′-dihydroxydiphenyl (DOD), 4,4′-dihydroxybenzophenone, bis(2-hydroxynaphth-1-yl)methane, bis(4-hydroxynaphth-1-yl)methane, 1,5-dihydroxynaphthalene, tris(4-hydroxyphenyl)methane, 1,1,2,2-tetrakis(4-hydroxyphenyl)ethane, bis(4-hydroxyphenyl) ether or bis(4-hydroxyphenyl) sulfone.

In one particular embodiment, the epoxy resin may be a diglycidyl ether of:
bisphenol A, bisphenol F or bisphenol A/F, where A stands for acetone and F for formaldehyde, which served as reactants for the preparation of these bisphenols; wherein in the case of bisphenol F, positional isomers may also be present, especially derived from 2,4′- or 2,2′-hydroxyphenylmethane.

In one embodiment, the epoxy resin may be a liquid epoxy resin, in particular based on a bisphenol. For instance, the epoxy resin may be a diglycidyl ether bisphenol A and/or a diglycidyl ether bisphenol F. In one embodiment, the epoxy resin may be a diglycidyl ether bisphenol F. In another embodiment, the epoxy resin may be a diglycidyl ether bisphenol A. For instance, the epoxy resin may have the following structure:

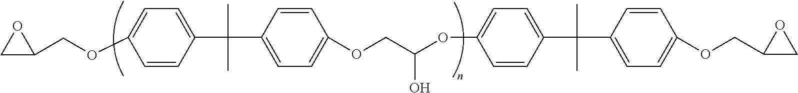

wherein
n is 0 or an integer of 1 or more.

As indicated above, n is 0 or an integer of 1 or more. In one embodiment, n is 0. In another embodiment, n is an integer of 1 or more. For instance, n may be 1 or more, such as 2 or more, such as 3 or more, such as 4 or more, such as 5 or more. In addition, n may be 10 or less, such as 9 or less, such as 8 or less, such as 7 or less, such as 6 or less, such as 5 or less, such as 4 or less, such as 3 or less, such as 2 or less. For instance, in one embodiment, n may be 1. In another embodiment, n may be 2. In a further embodiment, n may be 3.

In a further embodiment, the number of repeating units denoted by n may vary within an epoxy resin. For instance, the epoxy resin may include a mixture wherein n may be 0, 1, 2, 3, etc. for a respective resin. In this regard, the average number of repeating units may be within a particular range. For instance, the average may be 0 or more, such as 0.1 or more, such as 0.2 or more, such as 0.3 or more, such as 0.4 or more, such as 0.5 or more, such as 0.6 or more, such as 0.7 or more, such as 0.8 or more, such as 0.9 or more, such as 1 or more, such as 1.2 or more, such as 1.4 or more, such as 1.6 or more, such as 1.8 or more, such as 2 or more, such as 3 or more, such as 4 or more, such as 5 or more. The average may be 10 or less, such as 9 or less, such as 8 or less, such as 7 or less, such as 6 or less, such as 5 or less, such as 4 or less, such as 3 or less, such as 2 or less, such as 1.8 or less, such as 1.6 or less, such as 1.4 or less, such as 1.2 or less, such as 1 or less, such as 0.9 or less, such as 0.8 or less, such as 0.7 or less, such as 0.6 or less, such as 0.5 or less, such as 0.4 or less, such as 0.3 or less, such as 0.2 or less, such as 0.1 or less.

As indicated above, the epoxy resin may include an aliphatic polyepoxide or a cycloaliphatic polyepoxide. For instance, these may include, but are not limited to, the following:
glycidyl ethers of saturated or unsaturated, branched or unbranched, cyclic or open-chain di-, tri- or tetrafunctional C2 to C30 alcohols, especially ethylene glycol, propylene glycol, butylene glycol, hexanediol, octanediol, polypropylene glycols, dimethylolcyclohexane, neopentyl glycol, dibromoneopentyl glycol, castor oil, trimethylolpropane, trimethylolethane, pentaerythritol, sorbitol or glycerol, or alkoxylated glycerol or alkoxylated trimethylolpropane;
a hydrogenated bisphenol A, F or NF liquid resin, or the glycidylation products of hydrogenated bisphenol A, F or NF;
an N-glycidyl derivative of amides or heterocyclic nitrogen bases, such as triglycidyl cyanurate or triglycidyl isocyanurate, or reaction products of epichlorohydrin with hydantoin;
epoxy resins from the oxidation of olefins such as, in particular, vinylcyclohexene, dicyclopentadiene, cyclohexadiene, cyclododecadiene, cyclododecatriene, isoprene, 1,5-hexadiene, butadiene, polybutadiene or divinylbenzene.

While the above provides examples of epoxy resins, it should be understood that the epoxy resin may include any combination of the aforementioned. For instance, it should be understood that the epoxy resin may include one or more, such as two or more epoxy resins, particularly based on the aforementioned.

The epoxy resin, prior to curing, may have a weight average molecular weight of about 150 g/mol or more, such as 200 g/mol or more, such as 250 g/mol or more, such as 300 g/mol or more, such as 350 g/mol or more, such as 400 g/mol or more, such as 450 g/mol or more, such as 500 g/mol or more, such as 550 g/mol or more, such as 600 g/mol or more, such as 650 g/mol or more, such as 700 g/mol or more, such as 750 g/mol or more, such as 800 g/mol or more, such as 850 g/mol or more, such as 900 g/mol or more, such as 950 g/mol or more, such as 1000 g/mol or more. The weight average molecular weight may be 1500 g/mol or less, such as 1450 g/mol or less, such as 1400 g/mol or less, such as 1350 g/mol or less, such as 1300 g/mol or less, such as 1250 g/mol or less, such as 1200 g/mol or less, such as 1150 g/mol or less, such as 1100 g/mol or less, such as 1050 g/mol or less, such as 1000 g/mol or less, such as 950 g/mol or less, such as 900 g/mol or less, such as 850 g/mol or less, such as 800 g/mol or less, such as 750 g/mol or less, such as 700 g/mol or less, such as 650 g/mol or less, such as 600 g/mol or less, such as 550 g/mol or less, such as 500 g/mol or less, such as 450 g/mol or less, such as 400 g/mol or less, such as 350 g/mol or less, such as 300 g/mol or less, such as 280 g/mol or less, such as 260 g/mol or less, such as 240 g/mol or less, such as 220 g/mol or less, such as 200 g/mol or less, such as 180 g/mol or less, such as 160 g/mol or less, such as 140 g/mol or less. The weight average molecular weight may be determined using means generally known in the art, such as gel permeation chromatography.

The epoxy resin may have a particular epoxy equivalent weight, which is defined as the weight of the resin (in grams) per epoxy group. In this regard, the epoxy equivalent weight may be 100 or more, such as 120 or more, such as 140 or more, such as 160 or more, such as 180 or more, such as 200 or more. The epoxy equivalent weight may be 500 or less, such as 450 or less, such as 400 or less, such as 380 or less, such as 350 or less, such as 330 or less, such as 300 or less, such as 280 or less, such as 260 or less, such as 240 or less, such as 220 or less, such as 200 or less, such as 190 or less, such as 180 or less, such as 170 or less, such as 160 or less, such as 150 or less. The epoxy equivalent weight may be determined in accordance with ASTM D1652-11 (2019).

The epoxy resin may have a particular epoxy percentage. For instance, the epoxy percentage may be 5% or more, such as 10% or more, such as 15% or more, such as 20% or more, such as 25% or more, such as 30% or more, such as 35% or more, such as 40% or more, such as 45% or more, such as 50% or more. The epoxy percentage may be 80% or less, such as 70% or less, such as 60% or less, such as 50% or less, such as 45% or less, such as 40% or less, such as 35% or less, such as 30% or less, such as 25% or less. The epoxy percentage may be determined in accordance with ASTM D1652-11 (2019).

### Amine Compound

In general, the amine compound as disclosed herein for curing the epoxy resin may also typically be referred to as an amine (or aminic) antioxidant. In this regard, such compounds may have an antioxidant attribute. Regardless, the present inventor has discovered that such amine compounds may also be capable of functioning for other purposes, such as for curing epoxy resins to form a cured epoxy resin.

The amine compound may be a multiamine compound. For instance, a multiamine compound generally refers to an amine compound including two or more amine groups. In this regard, the amine compound may be a diamine, a triamine, or a mixture thereof. In one embodiment, the amine compound may be a triamine. For instance, such triamine may include three amine groups. In one particular embodiment, the amine compound may be a diamine. For instance, such diamine may include two amine groups.

The amine compound may include a primary amine, a secondary amine, a tertiary amine, or a mixture thereof. In particular, a respective amine group of an amine compound may be a primary amine, a secondary amine, a tertiary amine, or a mixture thereof. In one embodiment, the respective amine group may be a primary amine. In another embodiment, the respective amine group may be a tertiary amine. In one particular embodiment, the respective amine group may be a secondary amine. In one embodiment, at least one amine group of the amine compound may be a secondary amine. In another embodiment, each amine group of the amine compound may be a secondary amine.

When the amine compound is a diamine, in one embodiment, each amine group may be a primary amine. In another embodiment, each amine group may be a secondary amine. In a further embodiment, one amine group may be a primary amine while the other amine group may be a secondary amine. In an even further embodiment, each amine group may be a tertiary amine. In another further embodiment, one amine group may be a tertiary amine while the other amine group may be a primary amine group or a secondary amine group.

The amine compound may be an aromatic amine, an aliphatic amine, an aromatic/aliphatic amine, or a mixture thereof. In one embodiment, the amine compound may be an aromatic amine. In another embodiment, the amine compound may be an aliphatic amine. In a further embodiment, the amine compound may be an aromatic/aliphatic amine. For instance, the amine compound may include an aryl group having one or more aliphatic, such as alkyl, substituent groups bonded to at least one, such as at least two, of two or more nitrogen atoms of the amine compound.

In one embodiment, the amine compound may have the below structure of formula (I):

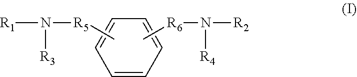

wherein
R₁ and R₂ are independently hydrogen, alkyl or aryl;
R₅ and R₄ are independently hydrogen or alkyl; and
R₅ and R₆ are independently a direct bond or a divalent radical.

In such formula (I), in one embodiment, the respective substituent groups may be bonded to different carbon atoms of the aromatic ring. For instance, in one embodiment, such respective substituent groups may be ortho, meta, or para with respect to each other. In one embodiment, they may be ortho. In another embodiment, they may be meta. In a further embodiment, they may be para.

In one embodiment, the substituent groups may be ortho with respect to each other. For instance, in particular, the amine compound may have the below structure of formula (Ia):

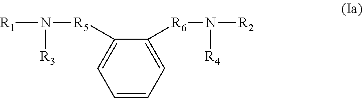

wherein
R₁ and R₂ are independently hydrogen, alkyl or aryl;
R₅ and R₄ are independently hydrogen or alkyl; and
R₅ and R₆ are independently a direct bond or a divalent radical.

In another embodiment, the substituent groups may be para with respect to each other. For instance, in particular, the amine compound may have the below structure of formula (Ib):

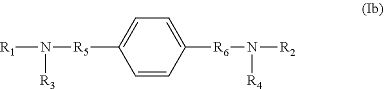

wherein
R₁ and R₂ are independently hydrogen, alkyl or aryl;
R₃ and R₄ are independently hydrogen or alkyl; and
R₅ and R₆ are independently a direct bond or a divalent radical.

As indicated above, R₁ and R₂ are independently hydrogen, alkyl or aryl. In one embodiment, R₁ is hydrogen. In another embodiment, R₁ is alkyl. In a further embodiment, R₁ is aryl. In one embodiment, R₂ is hydrogen. In another embodiment, R₂ is alkyl. In a further embodiment, R₂ is aryl. In general, in one embodiment, only one of R₁ and R₂ may be hydrogen. In another embodiment, both R₁ and R₂ are hydrogen.

As indicated above, R₃ and R₄ are independently hydrogen or alkyl. In one embodiment, R₃ is hydrogen. In another embodiment, R₃ is alkyl. In one embodiment, R₄ is hydrogen. In another embodiment, R₄ is alkyl. In general, in one embodiment, both R₅ and R₄ may be hydrogen. In another embodiment, only one of R₃ and R₄ may be hydrogen.

In addition, in one embodiment, at least one of R₁ and R₃ is not hydrogen. In this regard, R₁ is alkyl or aryl, such as alkyl, and/or R₃ is alkyl. Similarly, in one embodiment, at least one of R₂ and R₄ is not hydrogen. In this regard, R₂ is alkyl or aryl, such as alkyl, and/or R₄ is alkyl.

Regarding the alkyl, it may generally be a C₁-C₁₆ alkyl. For instance, the alkyl may be a C₁-C₁₆ alkyl, such as a C₁-C₁₄ alkyl, such as a C₁-C₁₂ alkyl, such as a C₁-C₁₀ alkyl, such as a C₁-C₈ alkyl, such as a C₁-C₆ alkyl, such as a C₁-C₄ alkyl, such as a C₁-C₈ alkyl, such as a C₁-C₂ alkyl. In this regard, the alkyl may have 1 or more, such as 2 or more, such as 3 or more, such as 5 or more, such as 8 or more carbon atoms. The alkyl may have 16 or less, such as 14 or less, such as 12 or less, such as 10 or less, such as 8 or less, such as 6 or less, such as 5 or less, such as 4 or less, such as 3 or less, such as 2 or less carbon atoms. In one embodiment, the alkyl may be a lower alkyl. For instance, the alkyl may be methyl in one embodiment.

Further, the alkyl may be linear or branched. In one embodiment, the alkyl may be linear. In another embodiment, the alkyl may be branched.

Regarding the aryl, it may be a C₃-C₁₂ aryl. In this regard, the aryl may be a C₃-C₁₂ aryl, such as a C₄-C₁₂ aryl, such as a C₆-C₁₂ aryl, such as a C₆-C₁₀ aryl, such as a C₆-C₈ aryl. For instance, the aryl may have 3 or more, such as 4 or more, such as 5 or more, such as 6 or more carbon atoms. The aryl may have 12 or less, such as 10 or less, such as 8 or less, such as 7 or less, such as 6 or less, such as 5 or less carbon atoms. In addition, in one embodiment, the aryl may be polycyclic. The polycyclic aryl may include fused, bridged, and spiro ring systems. In one particular embodiment, the aryl may be phenyl.

In one embodiment, the aforementioned alkyl may be substituted. For instance, the alkyl may be aryl substituted. Such substituent may be referred to as arylalkyl or arylkyl. Such alkyl and aryl groups may be as defined above.

In one embodiment, the aforementioned aryl may be substituted. For instance, the aryl may be alkyl substituted. Such substituent may be referred to as alkaryl. Such alkyl and aryl groups may be as defined above.

As indicated above, R₅ and R₆ are independently a direct bond or a divalent radical. In one embodiment, R₅ is a direct bond. In another embodiment, R₅ is a divalent radical. In one embodiment, R₆ is a direct bond. In another embodiment, R₆ is a divalent radical. In one embodiment, R₅ and R₆ are independently a direct bond. In another embodiment, R₅ and R₆ are independently a divalent radical.

The divalent radical may be an alkylene. For instance, the alkylene may be a C₁-C₅ alkylene, such as a C₁-C₈ alkylene, such as a C₁-C₂ alkylene, such as a C₁ alkylene. For instance, the alkylene may have 1 or more, such as 2 or more, such as 3 or more, such as 4 or more carbon atoms. The alkylene may have 5 or less, such as 4 or less, such as 3 or less, such as 2 or less carbon atoms. In one particular embodiment, the alkylene may be methylene.

In one embodiment, the amine compound may be a p-phenylenediamine based compound. For instance, in particular, the amine compound may have the below structure of formula (Ic):

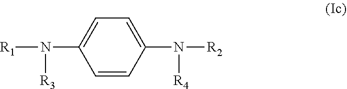

wherein
R₁ and R₂ are independently hydrogen, alkyl or aryl; and
R₃ and R₄ are independently hydrogen or alkyl.

In the aforementioned structure (Ic), the alkyl and aryl may be as defined above with respect to the structures of formulae (I), (Ia), and (Ib).

In one embodiment, the amine compound may be a triamine. For instance, the triamine may be a triazine based compound. In particular, the amine compound may have the below structure of formula (II):

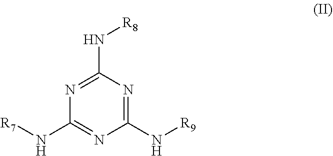

wherein R₇, R₈, and R₉ are independently alkyl or aryl.

For instance, in one embodiment, R₇ may be alkyl. In another embodiment, R₇ may be aryl. In one embodiment, R₈ may be alkyl. In another embodiment, R₈ may be aryl. In one embodiment, R₉ may be alkyl. In another embodiment, R₉ may be aryl. In one embodiment, at least two of R₇, R₈, and R₉ may be the same. In a further embodiment, all three of R₇, R₈, and R₉ may be the same. In another embodiment, all three of R₇, R₈, and R₉

Regarding the alkyl, it may be a C₁-C₁₆ alkyl. For instance, the alkyl may be a C₁-C₁₆ alkyl, such as a C₁-C₁₄ alkyl, such as a C₁-C₁₂ alkyl, such as a C₁-C₁₀ alkyl, such as a C₁-C₈ alkyl, such as a C₁-C₆ alkyl, such as a C₁-C₄ alkyl, such as a C₁-C₈ alkyl, such as a C₁-C₂ alkyl. In this regard, the alkyl may have 1 or more, such as 2 or more, such as 3 or more, such as 5 or more, such as 8 or more carbon atoms. The alkyl may have 16 or less, such as 14 or less, such as 12 or less, such as 10 or less, such as 8 or less, such as 6 or less, such as 5 or less, such as 4 or less, such as 3 or less, such as 2 or less carbon atoms. In one embodiment, the alkyl may be a lower alkyl. For instance, the alkyl may be methyl in one embodiment.

Further, the alkyl may be linear or branched. In one embodiment, the alkyl may be linear. In another embodiment, the alkyl may be branched.

Regarding the aryl, it may be a C₃-C₁₂ aryl. In this regard, the aryl may be a C₃-C₁₂ aryl, such as a C₄-C₁₂ aryl, such as a C₆-C₁₂ aryl, such as a C₆-C₁₀ aryl, such as a C₆-C₈ aryl. For instance, the aryl may have 3 or more, such as 4 or more, such as 5 or more, such as 6 or more carbon atoms. The aryl may have 12 or less, such as 10 or less, such as 8 or less, such as 7 or less, such as 6 or less, such as 5 or less carbon atoms. In addition, in one embodiment, the aryl may be polycyclic. The polycyclic aryl may include fused, bridged, and spiro ring systems. In one particular embodiment, the aryl may be phenyl.

In one embodiment, the aforementioned alkyl may be substituted. For instance, the alkyl may be aryl substituted. Such substituent may be referred to as arylalkyl or arylkyl. Such alkyl and aryl groups may be as defined above.

In one embodiment, the aforementioned aryl may be substituted. For instance, the aryl may be alkyl substituted. Such substituent may be referred to as alkaryl. Furthermore, such substitution may be an aminoalkyl (i.e., nitrogen of amino bonded to carbon of aryl) or alkylamine (i.e., carbon of alkyl bonded to carbon of aryl). In one embodiment, the substitution may be aminoalkyl. In this regard, such nitrogen may have a hydrogen substituent. Such alkyl and aryl groups may be as defined above. One example of such a compound having substitutions includes N, N′, N″-tris[4-[(1,4dimethylpentyl)amino]phenyl]-1,3,5-triazine-2,4,6-triamine (CAS No. 121246-28-4).

The amine compounds that may be utilized in accordance with the present disclosure may include, but are not limited to, poly(1,2-dihydro-2,2,4-trimethylquinoline) (CAS No. 26780-96-1); N,N-bis-(1,4-dimethylpentyl)-p-phenylenediamine (CAS No. 3081-14-9); 1,4-benzenediamine, N,N′-mixed phenyl and tolyl derivatives (CAS No. 68953-84-4); N, N′,N″-tris[4-[(1,4dimethylpentyl)amino]phenyl]-1,3,5-triazine-2,4,6-triamine (CAS No. 121246-28-4); N-isopropyl-N′-phenyl-1,4-phenylenediamine (CAS No. 101-72-4); bis(2,2,6,6tetramethyl-4-piperidyl) sebacate (CAS No. 52829-07-9); bis(1,2,2,6,6pentamethyl-4-piperidyl) sebacate (CAS No. 41556-26-7); poly[[6[(1,1,3,3-tetramethylbutyl)amino]-1,3,5-triazine-2,4-diyl][2,2,6,6-tetramethyl-4piperidiyl)imino]-1,6-hexanediyl[(2,2,6,6-tetramethyl-4-piperidiyl)imino]]) (CAS No. 70624-18-9); 1,5,8,12-tetrakis[4,6-bis(N-butyl-N-1,2,2,6,6pentamethyl-4-piperidylamino)-1,3,5˜triazin-2-yl]-1,5,8,12-tetraazadodecane (CAS No. 106990-43-6); N-(1,4-dimethylpentyl)-1,4-benzenediamine; N-1,3-dimethylbutyl-N′-phenyl-p-phenylenediamine (CAS No. 793-24-8); N,N′-di-2-butyl-1,4-phenylenediamine (CAS No. 101-96-2); N-1-(1,4-dimethylpentyl)-1,4-benzenediamine (CAS No. 63302-43-2); m-xylylenediamine (CAS No. 1477-55-0); diethyltoluene diamine (CAS No. 68479-98-1); polyoxypropylene triamine (CAS No. 39423-51-3) or a mixture thereof.

The amine compounds of formula (I) and/or (Ia) may include, but are not limited to, poly(1,2-dihydro-2,2,4-trimethylquinoline) (CAS No. 26780-96-1); N,N-bis-(1,4-dimethylpentyl)-p-phenylenediamine (CAS No. 3081-14-9); 1,4-benzenediamine, N,N′-mixed phenyl and tolyl derivatives (CAS No. 68953-84-4); N, N′,N″-tris[4-[(1,4dimethylpentyl)amino]phenyl]-1,3,5-triazine-2,4,6-triamine (CAS No. 121246-28-4); N-isopropyl-N′-phenyl-1,4-phenylenediamine (CAS No. 101-72-4); bis(2,2,6,6tetramethyl-4-piperidyl) sebacate (CAS No. 52829-07-9); bis(1,2,2,6,6pentamethyl-4-piperidyl) sebacate (CAS No. 41556-26-7); poly[[6[(1,1,3,3-tetramethylbutyl)amino]-1,3,5-triazine-2,4-diyl][2,2,6,6-tetramethyl-4piperidiyl)imino]-1,6-hexanediyl[(2,2,6,6-tetramethyl-4-piperidiyl)imino]]) (CAS No. 70624-18-9); 1,5,8,12-tetrakis[4,6-bis(N-butyl-N-1,2,2,6,6pentamethyl-4-piperidylamino)-1,3,5-triazin-2-yl]-1,5,8,12-tetraazadodecane (CAS No. 106990-43-6); N-(1,4-dimethylpentyl)-1,4-benzenediamine; N-1,3-dimethylbutyl-N′-phenyl-p-phenylenediamine (CAS No. 793-24-8); N,N′-di-2-butyl-1,4-phenylenediamine (CAS No. 101-96-2); N-1-(1,4-dimethylpentyl)-1,4-benzenediamine (CAS No. 63302-43-2); or a mixture thereof.

For instance, the amine compound may include N-isopropyl-N′-phenyl-1,4-phenylenediamine (CAS No. 101-72-4); 1,4-benzenediamine, N,N′-mixed phenyl and tolyl derivatives (CAS No. 68953-84-4); N,N-bis-(1,4-dimethylpentyl)-p-phenylenediamine (CAS No. 3081-14-9); N, N′,N″-tris[4-[(1,4dimethylpentyl)amino]phenyl]-1,3,5-triazine-2,4,6-triamine (CAS No. 121246-28-4); N-1,3-dimethylbutyl-N′-phenyl-p-phenylenediamine (CAS No. 793-24-8); N,N′-di-2-butyl-1,4-phenylenediamine (CAS No. 101-96-2); N-1-(1,4-dimethylpentyl)-1,4-benzenediamine (CAS No. 63302-43-2); or a mixture thereof. In one particular embodiment, the amine compound may comprise N-1,3-dimethylbutyl-N′-phenyl-p-phenylenediamine (CAS No. 793-24-8). In another particular embodiment, the amine compound may comprise N,N-bis-(1,4-dimethylpentyl)-p-phenylenediamine (CAS No. 3081-14-9).

As indicated herein, the amine compound may be a diamine. In this regard, the amine compound may include, but is not limited to, N, N′-diphenyl-p-phenylenediamine (CAS No. 74-31-7); N,N-bis-(1,4-dimethylpentyl)-p-phenylenediamine (CAS No. 3081-14-9); 1,4-benzenediamine, N,N′-mixed phenyl and tolyl derivatives (CAS No. 68953-84-4); N-isopropyl-N′-phenyl-1,4-phenylenediamine (CAS No. 101-72-4); bis(2,2,6,6tetramethyl-4-piperidyl) sebacate (CAS No. 52829-07-9); bis(1,2,2,6,6pentamethyl-4-piperidyl) sebacate (CAS No. 41556-26-7); N-(1,4-dimethylpentyl)-1,4-benzenediamine; N-1,3-dimethylbutyl-N′-phenyl-p-phenylenediamine (CAS No. 793-24-8); N, N′-di-2-butyl-1,4-phenylenediamine (CAS No. 101-96-2); N-1-(1,4-dimethylpentyl)-1,4-benzenediamine (CAS No. 63302-43-2); m-xylylenediamine (CAS No. 1477-55-0); or a mixture thereof.

As indicated herein, the amine compound may be a triamine. In this regard, the amine compound may include, but is not limited to, poly(1,2-dihydro-2,2,4-trimethylquinoline) (CAS No. 26780-96-1); N, N′,N″-tris[4-[(1,4dimethylpentyl)amino]phenyl]-1,3,5-triazine-2,4,6-triamine (CAS No. 121246-28-4); poly[[6[(1,1,3,3-tetramethylbutyl)amino]-1,3,5-triazine-2,4-diyl][2,2,6,6-tetramethyl-4piperidiyl)imino]-1,6-hexanediyl[(2,2,6,6-tetramethyl-4-piperidiyl)imino]]) (CAS No. 70624-18-9); or a mixture thereof.

The amine compounds of formula (II) and/or (IIa) may include, but are not limited to, m-xylylenediamine (CAS No. 1477-55-0).

In one embodiment, the amine compound may include N,N-bis-(1,4-dimethylpentyl)-p-phenylenediamine (CAS No. 3081-14-9), N,N′-di-2-butyl-1,4-phenylenediamine (CAS No. 101-96-2), m-xylylenediamine (CAS No. 1477-55-0), or a mixture thereof. In one embodiment, the amine compound may include N,N-bis-(1,4-dimethylpentyl)-p-phenylenediamine (CAS No. 3081-14-9), N,N′-di-2-butyl-1,4-phenylenediamine (CAS No. 101-96-2), or a mixture thereof. In one embodiment, the amine compound may be N-bis-(1,4-dimethylpentyl)-p-phenylenediamine (CAS No. 3081-14-9). In another embodiment, the amine compound may be N,N′-di-2-butyl-1,4-phenylenediamine (CAS No. 101-96-2).

In one embodiment, the amine compound may be a sterically hindered amine compound. In this regard, the nitrogen atom may be at least partially shielded by neighboring groups. In this regard, the amine compound may include at least one benzene ring bonded to the nitrogen of at least one amine group. In one embodiment, the amine compound may include at least one benzene ring bonded to the nitrogen of at least two amine groups. In one embodiment, the amine compound may include at least one alkyl group bonded to the nitrogen of at least one amine group. In one embodiment, the amine compound may include at least one alkyl group bonded to the nitrogen of at least two amine groups. In a further embodiment, the amine compound may include at least one benzene ring and at least one alkyl group bonded to the nitrogen of at least one amine group. In one embodiment, the amine compound may include at least one benzene ring and at least one alkyl group bonded to the nitrogen of at least two amine groups.

The amine compound may have a particular weight. For instance, the molecular weight may be 120 g/mol or more, such as 130 g/mol or more, such as 140 g/mol or more, such as 150 g/mol or more, such as 160 g/mol or more, such as 170 g/mol or more, such as 180 g/mol or more, such as 190 g/mol or more, such as 200 g/mol or more, such as 210 g/mol or more, such as 220 g/mol or more, such as 230 g/mol or more, such as 240 g/mol or more, such as 250 g/mol or more, such as 260 g/mol or more, such as 270 g/mol or more, such as 280 g/mol or more, such as 290 g/mol or more, such as 300 g/mol or more, such as 325 g/mol or more, such as 350 g/mol or more, such as 375 g/mol or more, such as 400 g/mol or more, such as 425 g/mol or more, such as 450 g/mol or more, such as 475 g/mol or more, such as 500 g/mol or more, such as 550 g/mol or more, such as 600 g/mol or more, such as 650 g/mol or more, such as 700 g/mol or more. The molecular weight may be 1000 g/mol or less, such as 950 g/mol or less, such as 900 g/mol or less, such as 850 g/mol or less, such as 800 g/mol or less, such as 750 g/mol or less, such as 700 g/mol or less, such as 650 g/mol or less, such as 600 g/mol or less, such as 550 g/mol or less, such as 500 g/mol or less, such as 450 g/mol or less, such as 400 g/mol or less, such as 350 g/mol or less, such as 300 g/mol or less, such as 280 g/mol or less, such as 260 g/mol or less, such as 240 g/mol or less, such as 220 g/mol or less, such as 200 g/mol or less, such as 180 g/mol or less, such as 160 g/mol or less, such as 140 g/mol or less.

In one embodiment, the amine compound may include more than one amine compound as defined herein. For instance, the amine compound may include a mixture of amine compounds. In this regard, the amine compound may include at least two amine compounds (e.g., a first amine compound and a second amine compound) as defined herein. Such mixture of amine compounds may be a mixture of any of the amine compounds as mentioned herein. In this regard, such amine compounds may also have any of the structures as mentioned herein. For instance, each amine compound may independently have the structure of formula (I), such as (Ia), (Ib), or (Ic). In particular, each amine compound may independently have the structure of formula (Ia) or (Ic).

In one embodiment, the first amine compound may include a compound formula (I), in particular formula (Ib) and even more particularly formula (Ic). In addition, the second amine compound may also include a compound of formula (I), in particular formula (Ia).

In this regard, in one embodiment, the amine compound may include N,N-bis-(1,4-dimethylpentyl)-p-phenylenediamine (CAS No. 3081-14-9), N,N′-di-2-butyl-1,4-phenylenediamine (CAS No. 101-96-2), or a mixture thereof in combination with m-xylylenediamine (CAS No. 1477-55-0). For instance, in one embodiment, the amine compound may be a mixture of N-bis-(1,4-dimethylpentyl)-p-phenylenediamine (CAS No. 3081-14-9) and m-xylylenediamine (CAS No. 1477-55-0). In another embodiment, the amine compound may be a mixture of N,N′-di-2-butyl-1,4-phenylenediamine (CAS No. 101-96-2) and m-xylylenediamine (CAS No. 1477-55-0).

When present as a mixture, the amount of such first amine compound and second amine compound may be within a certain ratio. For instance, the ratio of the first amine compound to the second amine compound may be 0.1 or more, such as 0.2 or more, such as 0.3 or more, such as 0.4 or more, such as 0.5 or more, such as 0.6 or more, such as 0.7 or more, such as 0.8 or more, such as 0.9 or more, such as 1 or more, such as 1.5 or more, such as 2 or more, such as 3 or more, such as 5 or more. The ratio may be 10 or less, such as 8 or less, such as 6 or less, such as 5 or less, such as 4 or less, such as 3 or less, such as 2.5 or less, such as 2 or less, such as 1.8 or less, such as 1.6 or less, such as 1.4 or less, such as 1.2 or less, such as 1.1 or less, such as 1 or less, such as 0.8 or less, such as 0.6 or less. In one embodiment, the aforementioned ratio may be a weight ratio. In another embodiment the aforementioned ratio may be a molar ratio. In a further embodiment, the aforementioned ratio may be an amine equivalent ratio.

Related, the first amine compound may be provided in an amount of 10 wt. % or more, such as 15 wt. % or more, such as 20 wt. % or more, such as 25 wt. % or more, such as 30 wt. % or more, such as 35 wt. % or more, such as 40 wt. % or more, such as 45 wt. % or more, such as 50 wt. % or more, such as 55 wt. % or more, such as 60 wt. % or more, such as 65 wt. % or more, such as 70 wt. % or more, such as 75 wt. % or more, such as 80 wt. % or more, such as 85 wt. % or more, such as 90 wt. % or more based on the total weight of the first amine compound and the second amine compound. The first amine compound may be provided in an amount of 90 wt. % or less, such as 85 wt. % or less, such as 80 wt. % or less, such as 75 wt. % or less, such as 70 wt. % or less, such as 65 wt. % or less, such as 60 wt. % or less, such as 55 wt. % or less, such as 50 wt. % or less, such as 45 wt. % or less, such as 40 wt. % or less, such as 35 wt. % or less, such as 30 wt. % or less, such as 25 wt. % or less, such as 20 wt. % or less, such as 15 wt. % or less, such as 10 wt. % or less based on the total weight of the first amine compound and the second amine compound. In one embodiment, such aforementioned weight percentages may apply to the entire mixture of amine compounds utilized.

The second amine compound may be provided in an amount of 10 wt. % or more, such as 15 wt. % or more, such as 20 wt. % or more, such as 25 wt. % or more, such as 30 wt. % or more, such as 35 wt. % or more, such as 40 wt. % or more, such as 45 wt. % or more, such as 50 wt. % or more, such as 55 wt. % or more, such as 60 wt. % or more, such as 65 wt. % or more, such as 70 wt. % or more, such as 75 wt. % or more, such as 80 wt. % or more, such as 85 wt. % or more, such as 90 wt. % or more based on the total weight of the first amine compound and the second amine compound. The second amine compound may be provided in an amount of 90 wt. % or less, such as 85 wt. % or less, such as 80 wt. % or less, such as 75 wt. % or less, such as 70 wt. % or less, such as 65 wt. % or less, such as 60 wt. % or less, such as 55 wt. % or less, such as 50 wt. % or less, such as 45 wt. % or less, such as 40 wt. % or less, such as 35 wt. % or less, such as 30 wt. % or less, such as 25 wt. % or less, such as 20 wt. % or less, such as 15 wt. % or less, such as 10 wt. % or less based on the total weight of the first amine compound and the second amine compound. In one embodiment, such aforementioned weight percentages may apply to the entire mixture of amine compounds utilized.

### Impact Modifier

In one embodiment, the cured epoxy resin may also include an impact modifier. The impact modifier may be utilized to improve the mechanical properties of the cured epoxy resin if necessary.

The impact modifier may include, but is not limited to, a butadiene elastomer, a silicone elastomer, an acrylic copolymer, or a mixture thereof. In one embodiment, the impact modifier may be a butadiene elastomer. In another embodiment, the impact modifier may be a silicone elastomer. In a further embodiment, the impact modifier may be an acrylic polymer.

As indicated above, in one embodiment, the impact modifier may be a butadiene elastomer. In this regard, the impact modifier may be polybutadiene, a butadiene copolymer, or a mixture thereof. In one embodiment, the impact modifier may be polybutadiene. In another embodiment, the impact modifier may be a butadiene copolymer. The butadiene copolymer may be a butadiene acrylonitrile copolymer. Furthermore, such butadiene acrylonitrile copolymer may have a functional termination. Such functional termination may be amino and/or carboxyl. In this regard, the butadiene acrylonitrile copolymer may be an amino-terminated butadiene acrylonitrile copolymer in one embodiment. In another embodiment, the butadiene acrylonitrile copolymer may be a carboxyl-terminated butadiene acrylonitrile copolymer.

In one embodiment, the impact modifier may be a silicone elastomer. The silicone elastomer may be a polyorganosiloxane in one embodiment. For instance, such polyorganosiloxane may have the following general formula:

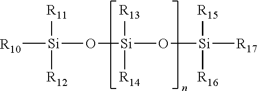

wherein,
n is an integer greater than 1; and
R₁₀, R₁₁, R₁₂, R₁₃, R₁₄, R₁₅, R₁₆, and R₁₇ are independently hydrogen or a monovalent group typically containing from 1 to about 20 carbon atoms, such as alkyl groups (e.g., methyl, ethyl, propyl, butyl, pentyl, octyl, etc.); alkoxy groups (e.g., methoxy, ethoxy, propoxy, etc.); carboxyalkyl groups (e.g., acetyl); cycloalkyl groups (e.g., cyclohexyl); alkenyl groups (e.g., vinyl, allyl, butenyl, hexenyl, etc.); aryl groups (e.g., phenyl, tolyl, xylyl, benzyl, 2-phenylethyl, etc.); and halogenated hydrocarbon groups (e.g., 3,3,3-trifluoropropyl, 3-chloropropyl, dichlorophenyl, etc.).

In one embodiment, such respective R₁₀, R₁₁, R₁₂, R₁₃, R₁₄, R₁₅, R₁₆, and R₁₇ may be a hydrogen. In one embodiment, such respective R₁₀, R₁₁, R₁₂, R₁₃, R₁₄, R₁₅, R₁₆, and R₁₇ may be a monovalent group containing from 1 to about 20 carbon atoms. Such group may contain 1 or more, such as 2 or more, such as 3 or more, such as 4 or more, such as 5 or more, such as 8 or more, such as 10 or more carbon atoms. Such group may contain 20 or less, such as 16 or less, such as 12 or less, such as 8 or less, such as 6 or less, such as 4 or less, such as 3 or less, such as 2 or less carbon atoms. In one embodiment, such group may contain 1 carbon atom.

Furthermore, such monovalent group in one embodiment may be an alkyl. For instance, the alkyl may be methyl, ethyl, propyl, butyl, pentyl, etc. In one embodiment, the alkyl may be methyl.

Regardless, examples of such polyorganosiloxanes may include, for instance, polydimethylsiloxane (“PDMS”), polymethylhydrogensiloxane, dimethyidiphenylpolysiloxane, dimethyl/methylphenylpolysiloxane, polymethylphenylsiloxane, methylphenyl/dimethylsiloxane, vinyldimethyl terminated polydimethylsiloxane, vinylmethyl/dimethylpolysiloxane, vinyldimethyl terminated vinylmethyl/dimethylpolysiloxane, divinylmethyl terminated polydimethylsiloxane, vinylphenylmethyl terminated polydimethylsiloxane, dimethylhydro terminated polydimethylsiloxane, methylhydro/dimethylpolysiloxane, methylhydro terminated methyloctylpolysiloxane, methylhydro/phenylmethyl polysiloxane, fluoro-modified polysiloxane, etc. as well as mixtures thereof.

In one embodiment, the impact modifier may be an acrylic copolymer. In general, it should be understood that acrylic copolymers also include acrylate copolymers. The acrylic copolymer may be an alternating copolymer, a random copolymer, or a block copolymer. In one embodiment, the acrylic copolymer may be a random copolymer. In another embodiment, the acrylic copolymer may be a block copolymer. The block may be a diblock in one embodiment. In another embodiment, the block may be a triblock.

Such acrylic copolymer may be formed by polymerizing two or more alkyl esters of propenoic acid. Such alkyl esters may be C₁-C₁₂ alkyl esters of acrylic or methacrylic acid. For instance, these may include, but are not limited to, methyl acrylate, methyl methacrylate, ethyl acrylate, ethyl methacrylate, propyl acrylate, propyl methacrylate, butyl acrylate, butyl methacrylate, 2-ethylhexyl acrylate, etc. and mixtures thereof. The ester group can comprise branched or unbranched C₁-C₈ alkyl groups or unbranched C₁-C₄ alkyl groups. In one embodiment, the acrylic copolymer may be formed from butyl acrylate and methyl methacrylate.

The impact modifier may be provided in a particular amount based on the weight of the cured epoxy resin. The impact modifier may be provided in an amount of 0.01 wt. % or more, such as 0.05 wt. % or more, such as 0.1 wt. % or more, such as 0.2 wt. % or more, such as 0.3 wt. % or more, such as 0.5 wt. % or more, such as 1 wt. % or more, such as 2 wt. % or more, such as 3 wt. % or more, such as 4 wt. % or more, such as 5 wt. % or more, such as 6 wt. % or more, such as 7 wt. % or more, such as 8 wt. % or more, such as 9 wt. % or more, such as 10 wt. % or more based on the weight of the cured epoxy resin. The impact modifier may be provided in an amount of 15 wt. % or less, such as 14 wt. % or less, such as 13 wt. % or less, such as 12 wt. % or less, such as 11 wt. % or less, such as 10 wt. % or less, such as 9 wt. % or less, such as 8 wt. % or less, such as 7 wt. % or less, such as 6 wt. % or less, such as 5 wt. % or less, such as 4 wt. % or less, such as 3 wt. % or less, such as 2 wt. % or less, such as 1.5 wt. % or less, such as 1 wt. % or less, such as 0.8 wt. % or less, such as 0.6 wt. % or less, such as 0.4 wt. % or less, such as 0.2 wt. % or less, such as 0.1 wt. % or less, such as 0.05 wt. % or less, such as 0.01 wt. % or less based on the weight of the cured epoxy resin. Furthermore, such aforementioned weight percentages may apply based on the weight of the epoxy resin in one embodiment.

In one embodiment, the epoxy resin may not include any impact modifier. In this regard, it may be present in the cured epoxy resin in an amount of 0 wt. %.

### Additives

The cured epoxy resin, as well as the epoxy resin composition referenced herein for forming such cured epoxy resin, may include one or more additives as generally known in the art. For instance, these may include, but are not limited to, wetting agents, colorants, pigments, thermoplastics, fillers (carbon fiber, glass fiber, glass spheres, high aspect ratio fillers, etc.), UV blocking compounds, UV stabilizers, coupling agents, fluorescent compounds, viscosity controlling agents, reactive and non-reactive diluents, etc. as well as mixtures thereof.

When utilized, they may be present in an amount of about 0.01 wt. % or more, such as about 0.05 wt. % or more, such as about 0.1 wt. % or more, such as about 0.2 wt. % or more, such as about 0.3 wt. % or more, such as about 0.5 wt. % or more, such as about 0.8 wt. % or more, such as about 1 wt. % or more, such as about 1.5 wt. % or more, such as about 2 wt. % or more, such as about 2.5 wt. % or more, such as about 3 wt. % or more, such as about 3.5 wt. % or more, such as about 4 wt. % or more, such as about 4.5 wt. % or more, such as about 5 wt. % or more, such as about 6 wt. % or more, such as about 7 wt. % or more, such as about 8 wt. % or more, such as about 9 wt. % or more, such as about 10 wt. % or more, such as about 12 wt. % or more, such as about 15 wt. % or more, such as about 18 wt. % or more, such as about 20 wt. % or more based on the weight of the cured epoxy resin. They may be present in an amount of about 40 wt. % or less, such as about 38 wt. % or less, such as about 35 wt. % or less, such as about 33 wt. % or less, such as about 30 wt. % or less, such as about 27 wt. % or less, such as about 25 wt. % or less, such as about 23 wt. % or less, such as about 20 wt. % or less, such as about 17 wt. % or less, such as about 15 wt. % or less, such as about 13 wt. % or less, such as about 10 wt. % or less, such as about 8 wt. % or less, such as about 6 wt. % or less, such as about 5 wt. % or less, such as about 4.5 wt. % or less, such as about 4 wt. % or less, such as about 3.5 wt. % or less, such as about 3 wt. % or less, such as about 2.5 wt. % or less, such as about 2 wt. % or less, such as about 1.5 wt. % or less, such as about 1 wt. % or less, such as about 0.8 wt. % or less, such as about 0.6 wt. % or less, such as about 0.5 wt. % or less, such as about 0.4 wt. % or less, such as about 0.3 wt. % or less, such as about 0.1 wt. % or less based on the weight of the cured epoxy resin.

In one embodiment, such aforementioned weight ratios may be based on the weight of the epoxy resin utilized in forming the cured epoxy resin. In another embodiment, such aforementioned weight ratios may be based on the weight of the epoxy resin and the amine compound utilized in forming the cured epoxy resin. In a further embodiment, such aforementioned weight ratios may be based on the weight of the composition utilized in forming the cured epoxy resin.

### Cured Epoxy Resin

The cured epoxy resin may be formed using general techniques as known in the art. For instance, a composition including an epoxy resin and an amine compound as defined herein may first be provided. The epoxy resin may have two or more epoxy, such as glycidyl, groups. Thereafter, the epoxy resin may be cured, such as under conditions conducive to the formation of a cured epoxy resin.

Accordingly, the method of forming a cured epoxy resin or the method of curing an epoxy resin may include at least the following: providing a composition including an epoxy resin and an amine compound and curing the epoxy resin. For instance, such curing may be at conditions conducive to the formation of a cured epoxy resin. Such curing may result in the amine compound reacting with the epoxy groups, such as glycidyl groups, of the epoxy resin for forming a cured epoxy resin.

Furthermore, to the extent the cured epoxy resin includes an impact modifier as defined herein, the composition may also include an impact modifier. However, as mentioned above, in one embodiment, the cured epoxy resin may not include an impact modifier. In this regard, the composition may include 0.1 wt. % or less, such as 0.05 wt. % or less, such as 0.01 wt. % or less, such as 0 wt. % of impact modifier based on the weight of the epoxy resin.

For the curing, the amine compound may be present in an amount of 0.05 moles or more, such as 0.1 moles or more, such as 0.2 moles or more, such as 0.3 moles or more, such as 0.4 moles or more, such as 0.5 moles or more, such as 0.6 moles or more, such as 0.7 moles or more, such as 0.8 moles or more, such as 0.9 moles or more, such as 1 mole or more of amine hydrogens from the amine compound per mole of epoxy groups of the epoxy resin. The amine compound may be present in an amount of 5 moles or less, such as 4.5 moles or less, such as 4 moles or less, such as 3.5 moles or less, such as 3 moles or less, such as 2.5 moles or less, such as 2 moles or less, such as 1.8 moles or less, such as 1.6 moles or less, such as 1.4 moles or less, such as 1.2 moles or less, such as 1.1 moles or less, such as 1 mole or less, such as 0.9 moles or less, such as 0.8 moles or less, such as 0.7 moles or less, such as 0.6 moles or less of amine hydrogens from the amine compound per mole of epoxy groups. As defined herein, “amine hydrogen” refers to the hydrogen atoms of the amine groups, particularly any primary and secondary amine groups, of the amine compound. When utilizing a mixture of amine compounds, such aforementioned reference to amounts may be with respect to a first amine compound and/or a second amine compound. Alternatively, when utilizing a mixture of amine compounds, such aforementioned reference to amounts may be with respect to all of the amine compounds together.

The amine compound may be provided in an amount of 1 part or more, such as 2 parts or more, such as 3 parts or more, such as 5 parts or more, such as 8 parts or more, such as 10 parts or more, such as 13 parts or more, such as 15 parts or more, such as 18 parts or more, such as 20 parts or more, such as 23 parts or more, such as 25 parts or more, such as 28 parts or more, such as 30 parts or more, such as 33 parts or more, such as 35 parts or more, such as 38 parts or more, such as 40 parts or more, such as 43 parts or more, such as 45 parts or more based on 100 parts of the epoxy resin. The amine compound may be provided in an amount of 70 parts or less, such as 68 parts or less, such as 65 parts or less, such as 63 parts or less, such as 60 parts or less, such as 58 parts or less, such as 55 parts or less, such as 53 parts or less, such as 50 parts or less, such as 48 parts or less, such as 45 parts or less, such as 43 parts or less, such as 40 parts or less, such as 38 parts or less, such as 35 parts or less, such as 33 parts or less, such as 30 parts or less, such as 28 parts or less, such as 25 parts or less, such as 23 parts or less based on 100 parts of the epoxy resin. In one embodiment, such aforementioned parts may be based on weight. In another embodiment, such aforementioned parts may be based on moles.

The temperature at which curing occurs may be relatively low. For instance, the temperature may be 20° C. or more, such as 25° C. or more, such as 30° C. or more, such as 40° ° C. or more, such as 50° C. or more, such as 60° C. or more, such as 70° C. or more, such as 80° C. or more, such as 90° C. or more, such as 100° ° C. or more, such as 110° C. or more, such as 120° C. or more, such as 130° C. or more, such as 140° C. or more, such as 150° C. or more, such as 160° ° C. or more, such as 170° C. or more, such as 180° C. or more, such as 190° C. or more. The temperature may be 250° C. or less, such as 230° C. or less, such as 210° C. or less, such as 200° C. or less, such as 180ºC or less, such as 160° C. or less, such as 140° C. or less, such as 120° C. or less, such as 100° C. or less, such as 80° C. or less, such as 60° C. or less.

The amount of curing time is also not necessarily limited by the present disclosure. For instance, the curing time may be 0.1 hours or more, such as 0.2 hours or more, such as 0.3 hours or more, such as 0.5 hours or more, such as 0.8 hours or more, such as 1 hour or more, such as 2 hours or more, such as 3 hours or more, such as 4 hours or more, such as 5 hours or more, such as 6 hours or more, such as 8 hours or more, such as 10 hours or more, such as 12 hours or more, such as 14 hours or more, such as 16 hours or more, such as 18 hours or more, such as 20 hours or more, such as 24 hours or more, such as 28 hours or more. The curing time may be 48 hours or less, such as 44 hours or less, such as 40 hours or less, such as 36 hours or less, such as 32 hours or less, such as 28 hours or less, such as 24 hours or less, such as 20 hours or less, such as 18 hours or less, such as 16 hours or less, such as 14 hours or less, such as 12 hours or less, such as 10 hours or less, such as 9 hours or less, such as 8 hours or less, such as 7 hours or less, such as 6 hours or less, such as 5 hours or less, such as 4 hours or less, such as 3 hours or less, such as 2 hours or less.

The amine compound may be utilized at a particular amine to epoxy equivalent ratio. For instance, the ratio may be 0.001 or more, such as 0.005 or more, such as 0.01 or more, such as 0.05 or more, such as 0.1 or more, such as 0.2 or more, such as 0.3 or more, such as 0.4 or more, such as 0.5 or more, such as 0.6 or more, such as 0.7 or more, such as 0.8 or more, such as 0.9 or more, such as 1 or more, such as 1.5 or more, such as 2 or more, such as 3 or more, such as 5 or more. The ratio may be 10 or less, such as 8 or less, such as 6 or less, such as 5 or less, such as 4 or less, such as 3 or less, such as 2.5 or less, such as 2 or less, such as 1.8 or less, such as 1.6 or less, such as 1.4 or less, such as 1.2 or less, such as 1.1 or less, such as 1 or less, such as 0.8 or less, such as 0.6 or less.

The amine to epoxy equivalent ratio may be 100:0 or less such as 95:5 or less, such as 90:10 or less, such as 85:5 or less, such as 80:20 or less, such as 75:25 or less, such as 70:30 or less, such as 65:35 or less, such as 60:40 or less, such as 55:45 or less, such as 50:50 or less, such as 45:55 or less, such as 40:60 or less, such as 35:65 or less, such as 30:70 or less, such as 25:75 or less, such as 20:80 or less, such as 15:85 or less, such as 10:90 or less, such as 5:95 or less, such as 0:100. The amine to epoxy equivalent ratio may be 0:100 or more, such as 5:95 or more, such as 10:90 or more, such as 15:85 or more, such as 20:80 or more, such as 25:75 or more, such as 30:70 or more, such as 35:65 or more, such as 40:60 or more, such as 45:55 or more, such as 50:50 or more, such as 55:45 or more, such as 60:40 or more, such as 65:35 or more, such as 70:30 or more, such as 75:25 or more, such as 80:20 or more, such as 85:15 or more, such as 90:10 or more, such as 95:5 or more, such as 100:0.

In addition, the cured epoxy resin of the present disclosure is one formed by reacting an epoxy resin and an amine compound as defined herein. For instance, as indicated above, the amine compound, in particular a residue of the amine compound, may become a part of the cured epoxy resin. For instance, for curing the epoxy resin, the amine compound reacts with the epoxy group, such as a glycidyl group, of the epoxy resin. In this regard, the amine compound may have converted to a residue of the original amine compound and the epoxy resin may have converted to a residue of the epoxy resin. In other words, the amine compound and the epoxy resin may not be in their original form and may thus be considered residues. Accordingly, the amine compound, particularly a residue of the amine compound, may serve as a crosslink or bridge between epoxy resins, particularly residues of epoxy resins.

The cured epoxy resin may also include an impact modifier as disclosed herein. However, as indicated, the cured epoxy resin may not include an impact modified in one embodiment. Furthermore, the cured epoxy resin may also include one or more additives as disclosed herein.

The cured epoxy resins as disclosed herein may be utilized in a variety of applications in a number of industries and are thus not limited by the present disclosure in that regard. For instance, without intending to be limited, the industry may be the electronics industry, electrical industry, aerospace industry, automotive industry, sporting industry, consumer goods industry, apparel/footwear industry, etc. In addition, the cured epoxy resin may be utilized in applications related to coatings, composites, adhesives, laminates, etc.

In this regard, the present disclosure may also be directed to an article including the cured epoxy resin. For instance, the article may comprise a coating, a composite, an adhesive, or a laminate made from the cured epoxy resin. In one embodiment, the article may comprise a coating made from the cured epoxy resin. In another embodiment, the article may comprise a composite made from the cured epoxy resin. In a further embodiment, the article may comprise an adhesive made from the cured epoxy resin. In another further embodiment, the article may comprise a laminate made from the cured epoxy resin.

### EXAMPLES

### Example 1

A first amine compound and a second amine compound were utilized to determine the effectiveness of curing an epoxy resin. The first amine compound was N,N-bis-(1,4-dimethylpentyl)-p-phenylenediamine (CAS No. 3081-14-9) and the second amine compound was m-xylylenediamine (CAS No. 1477-55-0). The first amine compound and the second amine compound were blended at a 100:0, 80:20, 50:50, 20:80, and 0:100 amine equivalent ratio. The amine compounds were blended with D.E.R 331 (liquid epoxy resin—reaction product of epichlorohydrin and bisphenol-A) at an amine to epoxy equivalent ratio of 1 to 1.

In addition, in a 6^{th} sample, N,N′-di-2-butyl-1,4-phenylenediamine (CAS No. 101-96-2) was utilized as the amine compound and in a 7th sample, 4,4′-methylenebis(2-methylcyclohexylamine) (“DMDC”) (CAS No. 6864-37-5) was utilized as the amine compound.

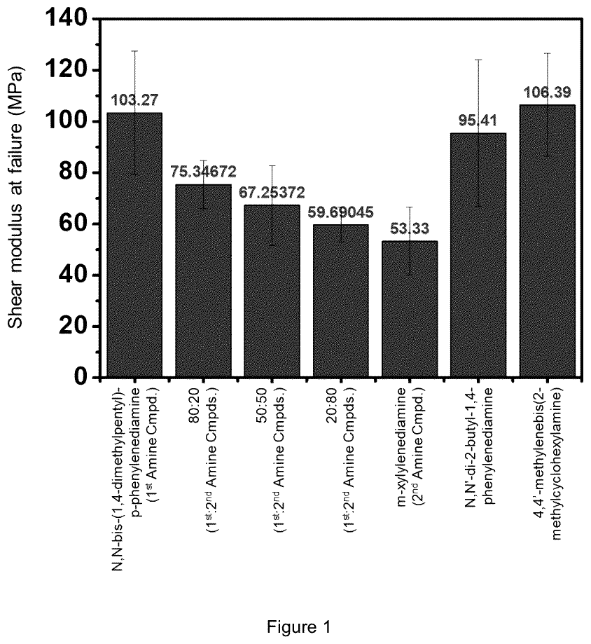

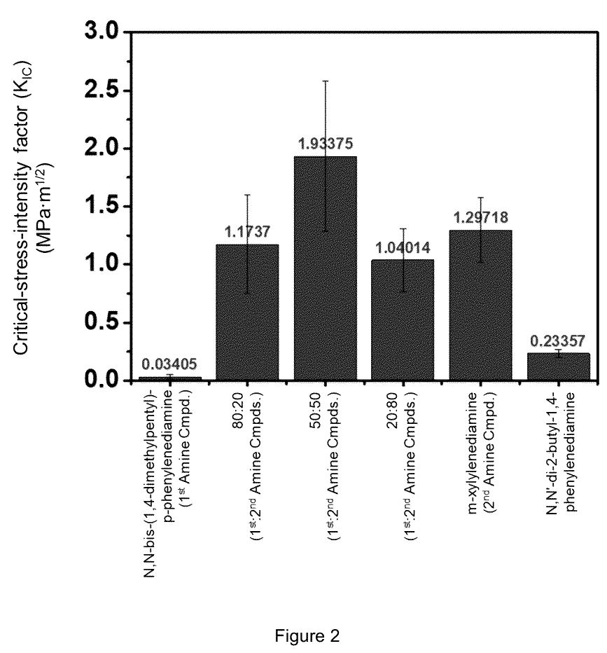

After curing, the cured epoxy resin was tested for various properties as shown in FIGS. 1 and 2. In particular, the shear modulus at failure was determined along with critical-stress-intensity factor (K_{IC}). The shear modulus at failure was determined in accordance with ASTM 5045-14. The critical-stress-intensity factor (K_{IC}) was determined in accordance with ASTM 5045-14.

The results demonstrate that the shear modulus at failure of the samples containing the blend of amine compounds falls between the shear modulus at failure of the samples when utilizing simply the respective components of the blend of amine compounds alone. However, the critical stress intensity factor, which is an indication of the fracture toughness, was greater for the sample based on the 50:50 blend than any other sample tested.

FIG. 1 depicts a bar graph of the shear modulus at failure of epoxy resins cured with amine compounds and amine compound blends. FIG. 1 depicts seven amine-containing samples: N,N-bis-(1,4-dimethylpentyl)-p-phenylenediamine (“1^{st} amine compound”); m-xylylenediamine (“2^{nd} amine compound”); 3 blends of the aforementioned amines; N,N′-di-2-butyl-1,4-phenylenediamine; and 4,4′-methylenebis(2-methylcyclohexylamine). The amine compounds and amine compound blends were blended with a liquid epoxy resin (the reaction product of epichlorohydrin and bisphenol-A) at an amine to epoxy equivalent ratio of 1 to 1. Generally, while adhesives between two substrates can generally withstand perpendicular force, shear stress can break the two substrates apart if the shear modulus is too low to withstand the perpendicular force. In this regard, the higher the shear modulus, the higher the force needed to break apart the adhesives between the two substrates. Accordingly, the results show that N,N-bis-(1,4-dimethylpentyl)-p-phenylenediamine and N,N′-di-2-butyl-1,4-phenylenediamine exhibit a higher shear modulus that may be more desired compared to m-xylylenediamine.

FIG. 2 depicts a bar graph of the results of a fracture toughness test of the samples depicted in FIG. 1. In general, the critical stress intensity is tied to impact resistance, and the higher the impact force, the more impact the epoxy resin can withstand. The results indicate that the 50:50 blend of N, N-bis-(1,4-dimethylpentyl)-p-phenylenediamine and m-xylylenediamine exhibits a higher impact resistance that may be more desired compared to that of the compounds alone.

Meanwhile, Table 1 below provides the critical stress intensity factor of a dicyandiamide cured bisphenol A diglycidyl ether epoxy resin including certain additives for increasing the impact resistance. For example, M52N is an acrylic block copolymer and CTBN is a carboxyl-terminated butadiene-acrylonitrile copolymer. However, according to the values shown, the 50:50 blend of N,N-bis-(1,4-dimethylpentyl)-p-phenylenediamine and m-xylylenediamine exhibits an improved critical stress intensity factor compared to the utilization of such additives for increasing the impact resistance of a dicyandiamide cured bisphenol A diglycidyl ether epoxy resin.

| Loading | M52N | | CTBN | |
|---|---|---|---|---|
| Level | K_{IC} | T_{g} | K_{IC} | T_{g} |
| 0% | 0.88 ± 0.1 | 148.1 | 0.88 ± 0.1 | 148.1 |
| 2.50% | 1.32 ± 0.12 | 146.4 | 1.03 ± 0.12 | — |
| 5.00% | 1.64 ± 0.08 | 144.2 | 1.32 ± 0.12 | 139.1 |
| 10.00% | 1.82 ± 0.11 | 135.4 | 1.62 ± 0.08 | 129.2 |

These and other modifications and variations of the present disclosure may be practiced by those of ordinary skill in the art, without departing from the spirit and scope of the present disclosure. In addition, it should be understood that aspects of the various embodiments may be interchanged both in whole or in part. Furthermore, those of ordinary skill in the art will appreciate that the foregoing description is by way of example only and is not intended to limit the disclosure so further described in such appended claims.

What is claimed is:

1. A method of forming a cured epoxy resin, the method comprising
curing an epoxy resin in the presence of an amine compound comprising a diamine, a triamine, or a mixture thereof;
wherein the cured epoxy resin has a shear modulus at failure of 55 MPa or more as determined in accordance with ASTM 5045-14.

2. The method of claim 1, wherein the cured epoxy resin has a shear modulus at failure of 55 MPa or more to 500 or less as determined in accordance with ASTM 5045-14.

3. The method of claim 1, wherein the cured epoxy resin has a shear modulus at failure of 55 MPa or more to 200 MPa or less as determined in accordance with ASTM 5045-14.

4. The method of claim 1, wherein the cured epoxy resin exhibits a shear modulus at failure of 55 MPa or more to 95 MPa or less as determined in accordance with ASTM 5045-14.

5. The method of claim 1, wherein the cured epoxy resin exhibits a critical stress intensity factor (K_{IC}) of 0.25 MPa·m^{1/2} or more to 5 MPa·m^{1/2} or less as determined in accordance with ASTM 5045-14.

6. The method of claim 1, wherein the epoxy resin comprises a diglycidyl ether.

7. The method of claim 1, wherein the epoxy resin comprises a diglycidyl ether bisphenol A and/or a diglycidyl ether bisphenol F.

8. The method of claim 1, wherein the epoxy resin comprises a diglycidyl ether bisphenol A.

9. The method of claim 1, wherein the amine compound has the following structure: 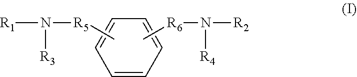
wherein
R₁ and R₂ are independently hydrogen, alkyl or aryl;
R₃ and R₄ are independently hydrogen or alkyl;
R₅ and R₆ are independently a direct bond or a divalent radical;
at least one of R₁ and R₃ is not hydrogen; and
at least one of R₂ and R₄ is not hydrogen.

10. The method of claim 1, wherein the amine compound has the following structure: 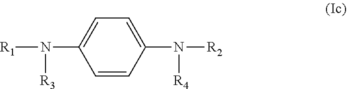
wherein
R₁ and R₂ are independently hydrogen, alkyl or aryl;
R₅ and R₄ are independently hydrogen or alkyl;
at least one of R₁ and R₃ is not hydrogen; and
at least one of R₂ and R₄ is not hydrogen.

11. The method of claim 1, wherein the amine compound comprises a diamine.

12. The method of claim 11, wherein the diamine comprises two amine groups and wherein each amine group is a secondary amine.

13. The method of claim 1, wherein the amine compound comprises a diamine comprising N,N′-diphenyl-p-phenylenediamine; N,N-bis-(1,4-dimethylpentyl)-p-phenylenediamine; 1,4-benzenediamine, N, N′-mixed phenyl and tolyl derivatives; N-isopropyl-N′-phenyl-1,4-phenylenediamine; bis(2,2,6,6-tetramethyl-4-piperidyl) sebacate; bis(1,2,2,6,6pentamethyl-4-piperidyl) sebacate; N-(1,4-dimethylpentyl)-1,4-benzenediamine; N-1,3-dimethylbutyl-N′-phenyl-p-phenylenediamine; N,N′-di-2-butyl-1,4-phenylenediamine; N-1-(1,4-dimethylpentyl)-1,4-benzenediamine; m-xylylenediamine; or a mixture thereof.

14. The method of claim 1, wherein the amine compound comprises N,N-bis-(1,4-dimethylpentyl)-p-phenylenediamine, N,N′-di-2-butyl-1,4-phenylenediamine, m-xylylenediamine, or a mixture thereof.

15. The method of claim 1, wherein the amine compound comprises a first amine compound and a second amine compound.

16. The method of claim 15, wherein the first amine compound has the following structure: 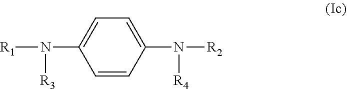
wherein
R₁ and R₂ are independently hydrogen, alkyl or aryl;
R₃ and R₄ are independently hydrogen or alkyl;
at least one of R₁ and R₃ is not hydrogen; and
at least one of R₂ and R₄ is not hydrogen.

17. The method of claim 15, wherein the second amine compound has the following structure: 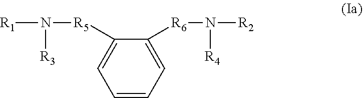
wherein
R₁ and R₂ are independently hydrogen, alkyl or aryl;
R₅ and R₄ are independently hydrogen or alkyl; and
R₅ and R₆ are a divalent radical.

18. The method of claim 15, wherein the first amine compound comprises N,N-bis-(1,4-dimethylpentyl)-p-phenylenediamine, N,N′-di-2-butyl-1,4-phenylenediamine, or a mixture thereof and the second amine compound comprises m-xylylenediamine.

19. The method of claim 1, wherein the cured epoxy resin comprises 0.1 wt. % or less of an impact modifier based on the weight of the cured epoxy resin.

20. A cured epoxy resin formed from the method of claim 1.
